(19) United States
(12) Patent Application Publication
(10) Pub. No.: US 2005/0039608 A1
(43) Pub. Date: Feb. 24, 2005

(54) Tunnel for treating food articles

(76) Inventor: Thomas Sollich, Kalletal (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/922,386

(22) Filed: Aug. 20, 2004

(30) Foreign Application Priority Data
Aug. 20, 2003 (DE) 103 38 214.3

(51) Int. Cl. A23L 1/00

(52) U.S. Cl. 99/352; 99/386; 99/443 C

(57) ABSTRACT

A tunnel (1) for treating food articles, especially for cooling, heating or drying sweets and candy, includes a conveying belt (15), a tempering plate (11), an insolating plate (4), a cover (5, 25) and a treating portion (3). The conveying belt (15) serves to transport the food articles in a longitudinal direction through the tunnel (1). The tempering plate (11) is arranged below the conveying belt (15), and it supports the conveying belt (15). The insolating plate (4) is arranged below the tempering plate (11) to form a free space (13) between the tempering plate (11) and the insolating plate (4). The insolating plate (4) has a surface (6) which declines in a direction transverse to the longitudinal direction of the tunnel (1). The treating portion (3) serves for the treatment of food articles, and it is defined between the cover (5, 25) and the insolating plate (4).

### CROSS REFERENCE TO RELATED APPLICATIONS

This application claims priority to co-pending German Patent Application No. 103 38 214.3 entitled “Tunnel zum Kühlen, Wärmen oder Trocknen von Nahrungsmitteln”, filed Aug. 20, 2003.

### FIELD OF THE INVENTION

The present invention generally relates to a tunnel for treating food articles, especially sweets and candy. More particularly, the present invention relates to a tunnel for cooling, heating or drying such food articles. Such sweets and candy may be chocolate bars, filled chocolates, and the like. The food articles are placed on a conveying belt which is transported through the tunnel in the longitudinal direction of the tunnel. During this movement, the articles are tempered, meaning they are treated with respect to temperature. Especially, the tunnel may include an upper cooling system and/or a bottom cooling system. Tempering, especially cooling, may be realized by using respectively tempered air or by using a different tempering medium.

### BACKGROUND OF THE INVENTION

A tunnel for treating food articles is known from German Patent No. DE 100 04 754 C1 corresponding to US Patent Application No. US 2001/0011587 A1. The known tunnel has a modular design, meaning it includes a plurality of modular units or sections located in series. Each section usually includes a frame-like lower part on which a tunnel section is arranged. A treating portion is formed in the upper part of the tunnel, the treating portion being defined by an insolating plate and by at least one cover. Usually, a plurality of covers is located one after the other in each section of the tunnel. The insolating plate as well as the cover fulfills an insolating function for the treating portion. The tunnel may include a cover which extends across the working width of the tunnel and which is supported on the insolating plate at the right hand side and at the left hand side of the tunnel. The cover may be alternately opened by a pivotal movement from the left hand side and from the right hand side of the tunnel, and it may be locked in the opened position. The cover may additionally or instead be designed to be removable. The upward pivotal movement and/or the removal of the cover serve to get access to the treating portion of the tunnel for purposes of cleaning, maintenance and inspection. The conveying belt is transported through the tunnel in the longitudinal direction thereof. The upper part of the conveying belt runs through the treating portion. The conveying belt is supported on and guided by, respectively, a tempering plate. The tempering plate is arranged above the insolating plate at a vertical distance thereto such that a free space is formed. The free space resulting in this way may be used as a channel for a tempering medium, especially cold air. In this way, the cold air realizes a bottom cooling system for the tempering plate and for the conveying belt. However, it is also possible to use a tempering liquid for the bottom cooling system. In such a case, the tempering plate is designed as a closed hollow chamber extending across the working width of the tunnel. The cooling liquid flows through the hollow chamber being located above the free space.

Another tunnel for cooling, heating or drying food articles, especially sweets and candy, is known from German Patent No. DE 102 18 009 C1. The known tunnel also includes a conveying belt which is guided above a tempering plate being arranged above and spaced apart from the bottom of a treating portion of the tunnel. The covers extending across the working width of the tunnel may be pivoted in an upward direction, and they may be locked in the upwardly pivoted position. This locked position may be realized by means of lifting apparatuses, especially gas pressure damper units, such that the treating portion may be accessed for cleaning purposes.

An important drawback of such known tunnels, especially cooling tunnels, is the difficulty of cleaning the tunnel with water as intensive as possible. For this purpose, the chambers and spaces of the treating portion have to be accessible. Cleaning of the surface of the conveying belt usually causes no difficulties. Other components of the treating portion may be easily accessed by upwardly pivoting the covers such that it is then possible to clean the components with water, and to dry the components in the following.

However, it is more difficult to clean the free space between the tempering plate and the insolating plate in known tunnels. In case there is a sufficient free space, the free space may only be accessed from the side when the covers are located in the upwardly pivoted position. Due to the fact that such cooling tunnels may have a working width of two meters and more, the middle portion of the free space cannot be reached by hand from the side. Consequently, it is known to use spray poles to clean the tunnel. With such spray poles, water under high pressure is sprayed onto the places to be cleaned in the treating portion of the tunnel. Following drying of the elements of the treating portion requires the use of tools with which the cleaning water is to be removed in a time consuming and complicated way. Thus, the tunnel cannot be used for production purposes before complete drying has been attained.

### SUMMARY OF THE INVENTION

The present invention relates to a tunnel for treating food articles. The tunnel includes a conveying belt, a tempering plate, an insolating plate, a cover and a treating portion. The conveying belt is designed and arranged to transport food articles in a longitudinal direction of the tunnel. The tempering plate is arranged below the conveying belt, and it is designed and arranged to support the conveying belt. The insolating plate is arranged below the tempering plate to form a free space between the tempering plate and the insolating plate. The insolating plate has a surface which declines in a direction transverse to the longitudinal direction of the tunnel. The treating portion serves for the treatment of food articles, and it is defined between the cover and the insolating plate.

The present invention also relates to a tunnel for treating food articles being conveyed through the tunnel. The tunnel includes a frame, a bottom member and a cover. The frame is designed and arranged to support the tunnel on the ground. The bottom member is supported on the frame. The bottom member has a top surface being designed and arranged to be inclined with respect to the ground. The cover has an opened position and a closed position. The cover and the bottom member in the closed position of the cover are designed and arranged to define an interior of the tunnel between them. The interior is insulated by the cover and the bottom member. The food articles are transported through the interior to be treated in the sense of cooling, heating or drying.

The novel tunnel may be easily cleaned such that a cleaning process only requires a comparatively short period of time.

The surface of the insolating plate (or bottom member) limiting and defining, respectively, the treating portion of the tunnel is not arranged to be horizontal, but in a declined way in a direction transverse to the longitudinal direction of the tunnel. In this way, the water which has been used for cleaning purposes may easily flow down the surface to exit the tunnel. When the tunnel is being cleaned, the water is especially sprayed onto the places to be cleaned by a spray pole. The water removes remainders of the food articles from the elements of the tunnel to be cleaned. During cleaning, the water reaches the lower portion of the treating portion located above the insolating plate. Due to the inclination and declination, respectively, of the insolating plate, the water flows down towards at least one side of the tunnel. The water may flow towards one side or towards both sides of the tunnel. In this way, undesired accumulation of cleaning water on the surface of the insolating plate is prevented. The angle of inclination may be in a range of approximately 1° to 15°, especially between 2° and 8°. The water can drip on the floor, or it may be intentionally removed by channels arranged in the floor. The surface of the insolating plate limiting the treating portion may be covered by a sheet and/or it may be treated to be water-repellant such that no more than water drops remain at the surface. These water drops may be removed by a tool, or they may be evaporated by warm air. In this way, the required period of time for cleaning the tunnel is substantially reduced compared to the prior art.

There are a number of possibilities of designing the surface of the insolating plate. The declination of the surface is realized by a shape similar to the one of a roof. Different roof-like shapes may be used, for example in the form of a monopitch roof, a gable roof, and the like. A monopitch roof includes a declined surface having its highest place at one longitudinal side of the tunnel, and it has its lowest place at the opposite side of the tunnel. This embodiment is especially suitable for tunnels having a comparatively small working width. It is to be understood that the working width extends perpendicular to the longitudinal direction of the tunnel. In tunnels having greater working widths, the highest point of the declined surface of the gable roof-like surface is located in the longitudinal center plane of the tunnel, meaning in the middle of the working width. The declined surface declines in a direction transverse to the longitudinal direction of the tunnel towards its two outer sides. It is also imaginable to design the surface of the insolating plate to have an inverted gable roof design to allow for removal of the water in the center portion of the tunnel below the insolating plate. Such a design is especially preferred for tunnels including a bottom cooling system in which a cooling liquid is used.

Removable supporting shafts serving for the temporary support of the conveying belt may be arranged above the tempering plate at a vertical distance thereto. For cleaning purposes, the associated tensioning device of the conveying belt is released, and the upper part of the conveying belt is then moved in an upward direction to be supported on the supporting shafts such that the distance between the upper part of the conveying belt and the tempering plate is increased to attain an enlarged space. This space is accessible by a spray pole, for example, over the entire working width of the tunnel. The supporting shafts are arranged to be spaced apart from one another as it is required for temporary suspension of the upper part of the conveying belt during cleaning.

Preferably, the insolating plate is made as a form body of plastic, especially foamed plastic. The declined surface of the insolating plate is realized during shaping of the insolating plate. The edge portions right and left at the insolating plate may include edge profiles to increase stability of the insolating plate and to prevent damages of the edges of the insolating plate.

The tunnel may include one or more covers extending across the working width of the tunnel. The covers may be arranged to be pivotable in an upward direction in an alternating way from the right hand side and from the left hand side of the tunnel and/or to be removable. Such a design especially relates to small working widths in which a plurality of covers is located one after the other at each module of the tunnel.

However, it is also possible that each section of the tunnel includes two covers located one next to the other in a way that the module includes twice the amount of covers compared to the tunnel described above. Such covers are then arranged as pairs to be pivotable about the longitudinal center plane of the tunnel and/or to be removable. This embodiment is especially suitable for great working widths or when the covers are made of stainless steel.

The tunnel may include a bottom tempering system. Preferably, the bottom tempering system is designed as a convection tempering system which uses the free space between the insolating plate and the tempering plate. The tempering plate is designed to be plain since the upper part of the conveying belt is supported and guided thereon during normal operation of the tunnel. The surface of the insolating plate limiting and defining, respectively, the treating portion has the above described declined surface for accelerated removal of cleaning water. The tunnel may also include an upper tempering system. Preferably, the upper tempering system is designed as a convection tempering system, and it uses the treating portion above the tempering plate. In this way, the space above the conveying belt and above the tempering plate, respectively, is used for the upper tempering system. At the same time, sufficient room for arranging the removable supporting shafts is available.

The declined surface of the insolating plate made of plastic may be connected to a sheet metal, especially a sheet metal made of stainless steel and the like. It also makes sense to arrange water-repellant materials on the surface of the insolating plate or on the surface of the cover plate.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a cross-sectional view of a first exemplary embodiment of the novel tunnel including an inclined insolating plate, the tunnel being shown in its working position.

FIG. 2 is a cross-sectional view of the tunnel according to FIG. 1 in its cleaning position.

FIG. 3 is a cross-sectional view of a second exemplary embodiment of the novel tunnel including an insolating plate, the tunnel being shown in its working position.

FIG. 4 is a cross-sectional view of the tunnel according to FIG. 3 in its cleaning position.

### DETAILED DESCRIPTION

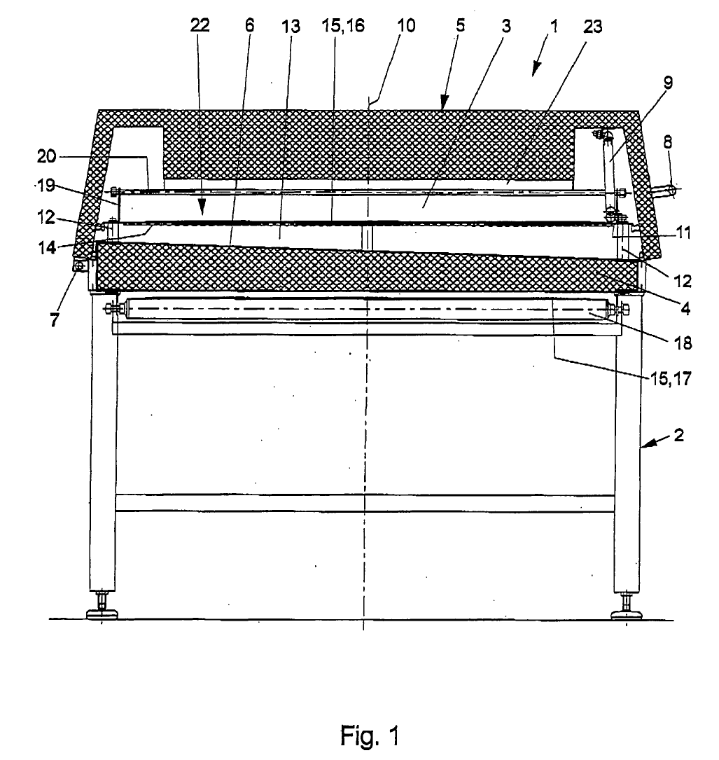

Referring now in greater detail to the drawings, FIG. 1 illustrates a cross sectional view of the novel tunnel 1. In other words, FIG. 1 is a view transverse to the longitudinal direction of the tunnel 1. It is to be understood that the entire tunnel 1 is designed to include a plurality of sections and of a plurality of interconnected tunnels 1, respectively, as it is generally known in the art. Each section of the tunnel 1 includes a supporting lower portion 2 which has a known frame-like design.

A treating portion 3 is located in the upper part of the tunnel 1. The treating portion 3 serves for treatment of the food articles, especially sweets and candy, to be processed in the tunnel 1. The treating portion 3 at its bottom side includes a bottom member or insolating plate 4, and at its upper side, it includes a cover 5. In other words, the lower end of the treating portion 3 is defined and limited by the insolating plate 4, and the upper end of the treating portion 3 is defined and limited by the cover 5. The insolating plate 4 includes an inclined surface 6 facing the treating portion 3. In this embodiment, the surface 6 is designed similar to a monopitch roof or a lean-to roof. In other words, the surface 6 at the left hand side of the tunnel 1 has its highest point, and at the right hand side of the tunnel 1 it has its lowest point. Consequently, the surface 6 is respectively inclined (or declined) with respect to the horizontal plane and the ground. The angle of inclination may be in a range of approximately 2° to 10°, especially between 4° and 8°.

In this embodiment of the tunnel 1, a cover 5 extends along the entire working width of the tunnel 1, and it is designed to be opened by a pivotal movement about a hinge 7. It is to be understood that the working width extends in a direction perpendicular with respect to the longitudinal direction of the tunnel 1. For the pivotal movement, the cover 5 includes a handle 8 being located at the right hand side of the tunnel 1. The hinge 7 is designed as a fixed hinge.

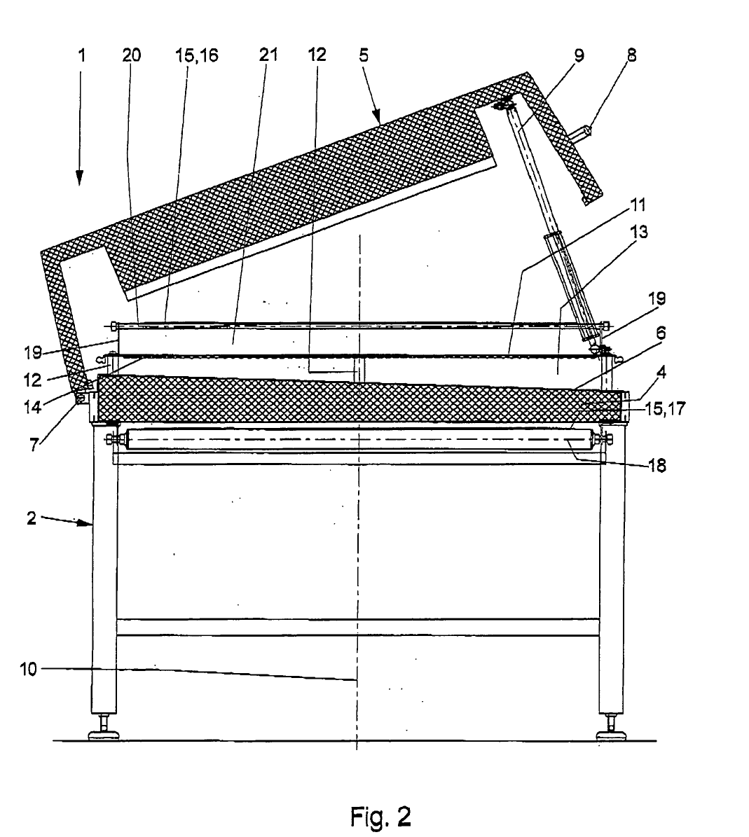

FIG. 2 illustrates the opened position of the tunnel 1. The opened position of the tunnel 1 is maintained and secured by a gas pressure spring 9. It is easily imaginable that it is also possible to design the tunnel 1 to include two hinges 7 and two handles 8 at both sides right and left of a longitudinal center plane 10 of the tunnel 1. The hinges 7 are then designed to be demountable such that the cover 5 may be alternately opened from the left hand side or from the right hand side and/or it may be completely removed from the frame 2.

A tempering plate 11 is located in the treating portion 3. The tempering plate 11 is supported on supports 12 in a way to be stationary. Due to the support on the supports 12 which is realized at certain points and in certain sections of the tunnel 1, respectively, the tempering plate 11 is located at a vertical distance with respect to the inclined surface 6 of the insolating plate 4 such that there is a free space 13 which may be freely reached from the side between two outer supports 12. The free space 13 forms a cross-section which may be used to guide tempered air, especially for a bottom cooling system using convection. The exemplary embodiment of the tunnel 1 in FIGS. 1 and 2 however illustrates a bottom cooling system using a tempering liquid circulating through a tempering circuit (not illustrated). For this purpose, the bottom side of the tempering plate 11 includes a profiled sheet 14. In the illustrated exemplary embodiment, the profiled sheet 14 has a corrugated design. The profiled sheet 14 is connected to the bottom side of the tempering plate 11 in a way such that a closed hollow space for the flow of the cooling liquid is realized. For example, the connection may be attained by welding. It is to be understood that the hollow space between the tempering plate 11 and the profiled sheet 14 extends along the entire working width of the tunnel 1 such that a uniform cooling effect is attained at each place.

A conveying belt 15 with its upper part 16 is guided on the stationary tempering plate 11. Articles of food are placed on the upper part 16 of the conveying belt 15, the articles being treated in the tunnel 1 with respect to temperature. The articles are not illustrated for reasons of clarity of the drawings. It is to be understood that the conveying belt 15 is driven. The conveying belt 15 moves in a longitudinal direction of the tunnel 1 through the treating portion 3. This means that it moves in a direction perpendicular with respect to the plane of illustration of FIG. 1. The conveying belt 15 also includes a lower part 17 which is supported by rollers 18 being supported at the lower portion 2 outside of the treating portion 3 and below of the insolating plate 4. In this way, the conveying belt 15 rotates along a closed path as it is generally known in the art.

Supporting shafts 20 are located in the treating portion 3 above the upper part 16 of the conveying belt 15 and spaced apart to the conveying belt 15. The supporting shafts 20 are supported on stationary supports 19. The supporting shafts 20 are arranged in a spaced apart manner in the longitudinal direction of the tunnel 1. The supporting shafts 20 may be removed from the supports 19, and they may be reconnected to the supports 19. The supporting shafts 20 serve to support the upper part 16 of the conveying belt 15 in the cleaning position of the tunnel 1, as this is illustrated in FIG. 2. In the cleaning position of the tunnel 1, the gap between lower surface of the upper part 16 of the conveying belt 15 and the upper surface of the tempering plate 11 is increased. In this way, a chamber 21 is easily accessible from the side.

An upper tempering system 22 may be arranged in the upper part of the treating portion 3, meaning above the tempering plate 11 and above the upper part 16 of the conveying belt 15, respectively. Preferably, the upper tempering system 22 is realized by convection. This means that respectively tempered air flows through this part of the treating portion 3 which forms a channel. Turbulence sheets 23 may be arranged at the bottom side of the cover 5 for attaining a swirling effect of the flow of air. The bottom sides of the food articles are treated by a bottom cooling system and a bottom tempering system, respectively. In the illustrated embodiment of the tunnel 1, the system uses a cooling medium which flows through the hollow space between the tempering plate 11 and the profiled sheet 14. Preferably, the insolating plate 4 and the cover 5 are made of foamed plastic. They may also be made of any other material having a comparatively great insolating effect. These insolating properties are indicated by crosshatching in the drawings. The cover 5 in its middle portion may include an especially thick insolating layer.

The cover 5 is opened by a pivotal movement to reach the cleaning position of the tunnel 1 according to FIG. 2. The opened position is secured by one or more gas pressure springs 9. The upper part 16 of the conveying belt 15 may be locally lifted after removal of a supporting shaft 20 after having released the tensioning device of the conveying belt 15. The upper part 16 of the conveying belt 15 may be supported on the supports 19 after reinsertion of the supporting shafts 20, as this is illustrated in FIG. 2. These disassembly and assembly steps are conducted along the section of the tunnel 1 and along the entire tunnel 1, respectively, which is intended to be cleaned. In this way, the treating portion 3 of the tunnel 1 may be freely accessed from the right hand side to direct cleaning water onto the upper side of the conveying belt 15, the lower side of the upper part 16 of the conveying belt 15, the upper side of the tempering plate 11 as well as the lower side of the tempering plate 11 and of the profiled sheet 14, respectively, and on the surface 6 of the insolating plate 4. Preferably, the cleaning water is sprayed with high pressure into the tunnel 1 by a spraying pole. In this way, all places of the treating portion 3 to be cleaned are accessible for cleaning. This includes the supports 12 and 19. The same applies to the lower side of the cover 5 as well as to possibly arranged additional components in the treating portion 3 which may serve to guide the air and which are not illustrated in greater detail. The water introduced for cleaning purposes flows along the declined surface 6 of the insolating plate 4 in a downward direction, and it carries parts of remainders of the food articles. The water may either be removed on the floor or with special channels which are not illustrated herein. If any, only a small amount of water in the form of drops remains in the treating portion 3 of the tunnel 1. This remainder of the water may be removed by a cleaning apparatus, or it may be evaporated with warm air in a way that the tunnel 1 is thoroughly cleaned and may be used for the production of food articles.

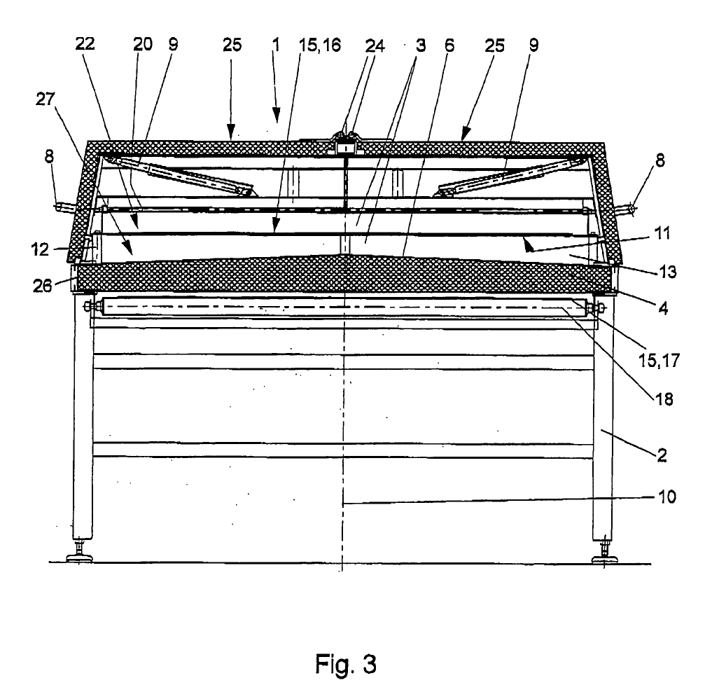

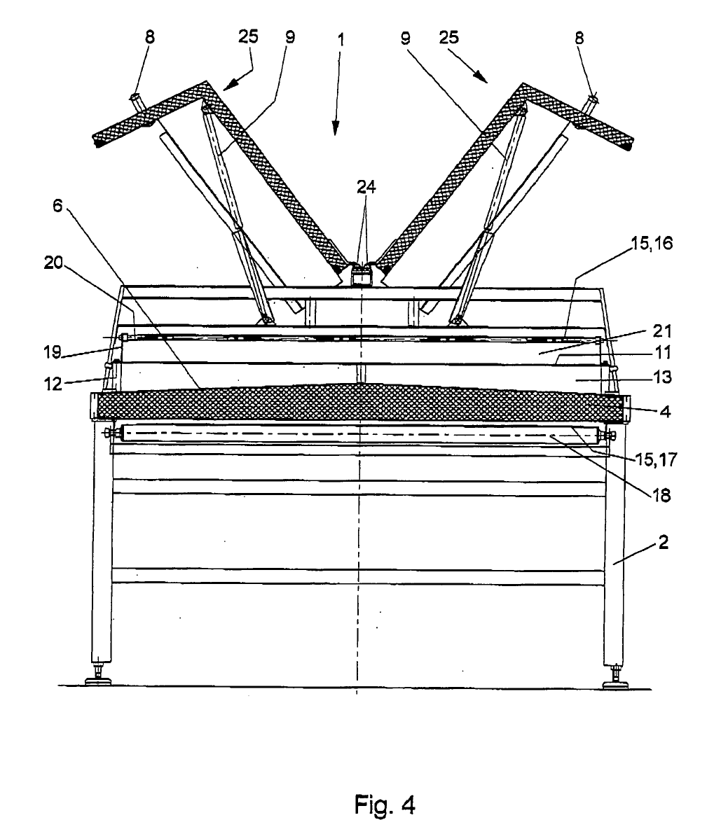

FIGS. 3 and 4 illustrate a cross-section of another exemplary embodiment of the novel tunnel 1. This embodiment of the tunnel 1 is especially suitable to be used for greater working widths. The surface 6 of the insolating plate 4 is designed similar to the general shape of a gable roof. This means that the highest place is located in the longitudinal center plane 10 of the tunnel 1, and that the declined surface 6 declines towards both outer sides of the tunnel 1. Two covers 25 are symmetrically arranged with respect to the longitudinal center plane 10. The covers 25 are supported by hinges 24 such that the left cover 25 may be opened from the left hand side of the tunnel 1, and the right cover 25 may be opened from the right hand side of the tunnel 1. The covers are opened by a pivotal upward movement, as this may be seen from a comparison of FIGS. 3 and 4. The tempering plate 11 is located above and spaced apart from the surface 6 of the insolating plate 4. The tempering plate 11 is arranged in a stationary way, and a free space 13 is formed. The free space 13 is accessible from both sides of the tunnel 1 in the cleaning position (see FIG. 4). The insolating plate 4 at its edges may include edge profiles 26 which may serve to increase stability of the comparatively great insolating plate 4. The surface 6 of the insolating plate 4 facing in an upward direction may include a cover sheet (not illustrated), especially a cover sheet made of stainless steel. It is also possible to use a water-repellent coating to improve flow off of the cleaning water. It is to be understood that such a tunnel module or tunnel section does not only include the two covers 25 illustrated in FIGS. 3 and 4, but also additional covers located in front of and behind the illustrated covers 25. In this way, the tunnel section includes a number of covers 25. In the exemplary embodiment of the novel tunnel 1 illustrated in FIGS. 3 and 4, the tempering plate 11 is designed as a supporting plate made of sheet metal. The tunnel 1 does not include the profiled sheet 14 illustrated in FIGS. 1 and 2. A bottom tempering system 27 is arranged below the tempering plate 11. The bottom tempering system 27 uses convection. For reasons of clarity of the drawings, the elements of the bottom tempering system 27, especially units guiding air, are not illustrated. However, these elements are generally known in the art and need not be explained herein in greater detail.

Many variations and modifications may be made to the preferred embodiments of the invention without departing substantially from the spirit and principles of the invention. All such modifications and variations are intended to be included herein within the scope of the present invention, as defined by the following claims.

1. A tunnel for treating food articles, comprising:
a conveying belt, said conveying belt being designed and arranged to transport food articles in a longitudinal direction of said tunnel;
a tempering plate, said tempering plate being arranged below said conveying belt and being designed and arranged to support said conveying belt;
an insolating plate, said insolating plate being arranged below said tempering plate to form a free space between said tempering plate and said insolating plate, said insolating plate having a surface which declines in a direction transverse to the longitudinal direction of said tunnel;
a cover; and
a treating portion, said treating portion being designed for treatment of food articles, said treating portion being defined between said cover and said insolating plate.

2. The tunnel of claim 1, wherein said declined surface of said insolating plate has a roof-like shape.

3. The tunnel of claim 1, wherein said surface of said insolating plate has at least one lowest part, said lowest part being located at at least one side of said tunnel.

4. The tunnel of claim 2, wherein said surface of said insolating plate has at least one lowest part, said lowest part being located at at least one side of said tunnel.

5. The tunnel of claim 1, further comprising a plurality of supporting shafts, said supporting shafts being arranged in said treating portion above said tempering plate and at a vertical distance to said tempering plate, said supporting shafts being designed to be removable and to support said conveying belt.

6. The tunnel of claim 1, wherein said insolating plate is designed as a body made of plastic.

7. The tunnel of claim 1, wherein said tunnel includes a plurality of sections being located in series in the longitudinal direction of said tunnel.

8. The tunnel of claim 7, further comprising a plurality of covers, each of said covers being associated with one of said sections and being designed and arranged to be opened by an upwardly directed pivotal movement.

9. The tunnel of claim 8, wherein each of said covers is designed and arranged to be removable.

10. The tunnel of claim 7, further comprising a plurality of covers, each of said covers being designed and arranged to be opened by an upwardly directed pivotal movement about the longitudinal center plane of said tunnel in a way that two covers are associated with one section.

11. The tunnel of claim 10, wherein each of said covers is designed and arranged to be removable.

12. The tunnel of claim 1, further comprising a bottom tempering system, said bottom tempering system being designed as a convection tempering system and to use the free space between said insolating plate and said tempering plate.

13. The tunnel of claim 1, further comprising an upper tempering system, said upper tempering system being designed as a convection tempering system and to use said treating portion above said tempering plate.

14. The tunnel of claim 1, wherein the declined surface of said insolating plate is covered by a sheet metal.

15. The tunnel of claim 14, wherein said sheet metal is made of stainless steel.

16. A tunnel for treating food articles to be conveyed through said tunnel, comprising:
a frame, said frame being designed and arranged to support said tunnel on the ground;
a bottom member, said bottom member being supported on said frame, said bottom member having a top surface, said top surface being designed and arranged to be inclined with respect to the ground; and
a cover, said cover having an opened position and a closed position, said cover and said bottom member in the closed position of said cover being designed and arranged to define an interior of said tunnel between them, the interior being insulated by said cover and said bottom member.

17. The tunnel of claim 16, wherein said top surface of said bottom member is arranged at an angle of declination of approximately between 2° and 10° with respect to the ground.

18. The tunnel of claim 17, further comprising a conveying belt, said conveying belt being designed and arranged to transport food articles in a longitudinal direction through said tunnel.

19. The tunnel of claim 18, further comprising a tempering plate, said tempering plate being arranged below said conveying belt and being designed and arranged to support said conveying belt.

20. The tunnel of claim 19, wherein said bottom member is arranged below said tempering plate to form a free space between said tempering plate and said bottom member.

21. The tunnel of claim 20, further comprising a treating portion, said treating portion being designed for treatment of food articles, said treating portion being defined between said cover and said bottom member.

22. The tunnel of claim 1, wherein said surface of said bottom member has at least one lowest part, said lowest part being located at at least one side of said tunnel.

23. The tunnel of claim 1, wherein said surface of said bottom member has one lowest part, said lowest part being located at one side of said tunnel.

24. The tunnel of claim 1, wherein said surface of said bottom member has two lowest parts, said lowest parts being located both sides of said tunnel.

25. The tunnel of claim 1, wherein said tunnel serves for cooling, heating and drying sweets and candy.
